(19) United States
(12) Patent Application Publication
(10) Pub. No.: US 2026/0023919 A1
(43) Pub. Date: Jan. 22, 2026

(54) CODE GENERATION FROM A DIGITAL IMAGE

(71) Applicant: Adobe Inc., San Jose, CA (US)

(72) Inventors: Ishika Goel, Gautam Buddha Nagar (IN); Varun Khurana, New Delhi (IN); Rishabh Jain, Gurgaon (IN); Rahul Gupta, Noida (IN); Mayank Gupta, Noida (IN); Anubhav Tripathi, Greater Noida West (IN)

(73) Assignee: Adobe Inc., San Jose, CA (US)

(21) Appl. No.: 18/779,576

(22) Filed: Jul. 22, 2024

(51) Int. Cl. G06F 40/143; G06V 10/70; G06V 10/74; G06V 30/414; G06V 30/418

(52) U.S. Cl. CPC G06F 40/143; G06V 10/70; G06V 10/761; G06V 30/414; G06V 30/418

(57) ABSTRACT

Code generation techniques from a digital image are described. In one or more examples, layout data is extracted from a digital image. The layout data describing a layout of elements included in the digital image. Markup language code is generated over one or more iterations of candidate markup code using a machine-learning model based on the digital image and the layout data and determining whether a similarity threshold is reached by comparing a candidate digital image generated using the candidate markup code with the digital image. The markup language code is output responsive to determining the similarity threshold is reached.

### BACKGROUND

Digital content is configurable in a variety of ways for output by a wide range of computing devices, e.g., desktop computers, mobile phones, tablet computers, and so forth. Techniques that have been developed to promote this output include use of a markup language, examples of which include a hypertext markup language (HTML), extensible markup language (XML), scalable vector graphics (SVG), mathematical markup language (MathML), and so forth.

Conventional techniques used to generate code for these various techniques, however, typically involve specialized knowledge using skills developed over a significant period of time in order to achieve a desired result. As such, conventional techniques often encounter coding inaccuracies in real-world scenarios and result in computational inefficiencies by computing devices that implement these conventional techniques.

### SUMMARY

Code generation techniques from a digital image are described. The code generation techniques are configurable to employ machine learning through use of a machine-learning model to generate code, e.g., markup language code or other types of code that are executable by a processing device. The code generation techniques are configurable to do so automatically and without user intervention from a digital image, e.g., captured from digital content. In one or more examples, the code generation techniques are configurable to extract layout data from the digital image and use the layout data as a guide along with the digital image as a prompt to a machine-learning model to generate the executable code. Further, the code generation techniques are also configurable to employ an iterative process to identify missing elements from candidate markup code and add those elements to a resulting markup language code that is executable to implement the digital content.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

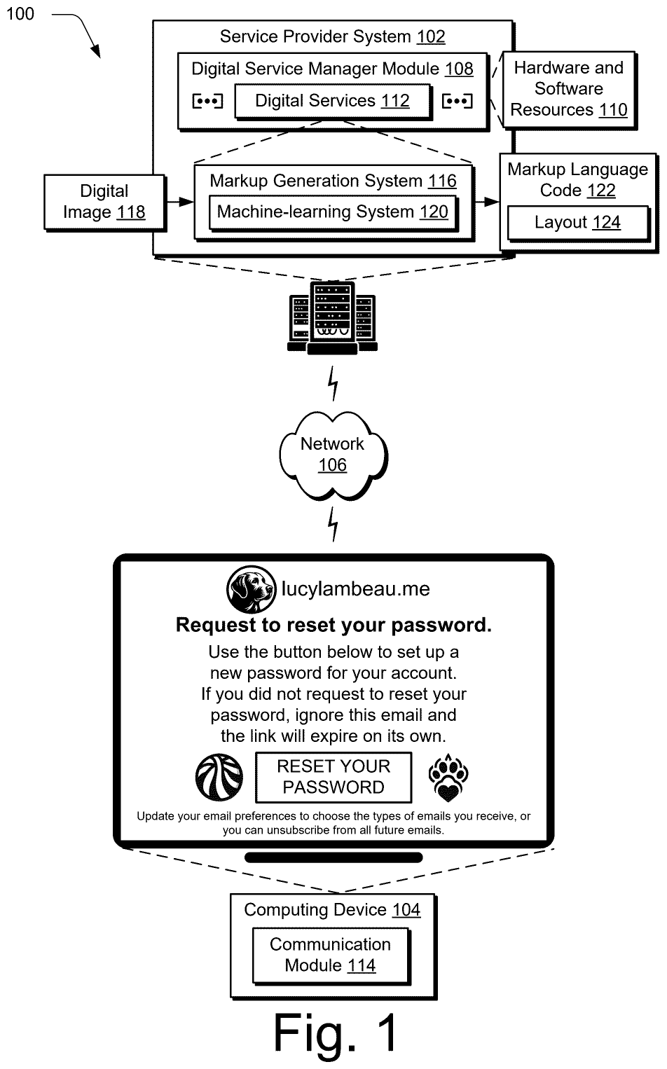

FIG. 1 is an illustration of a digital medium environment in an example implementation that is operable to employ code generation techniques from a digital image as described herein.

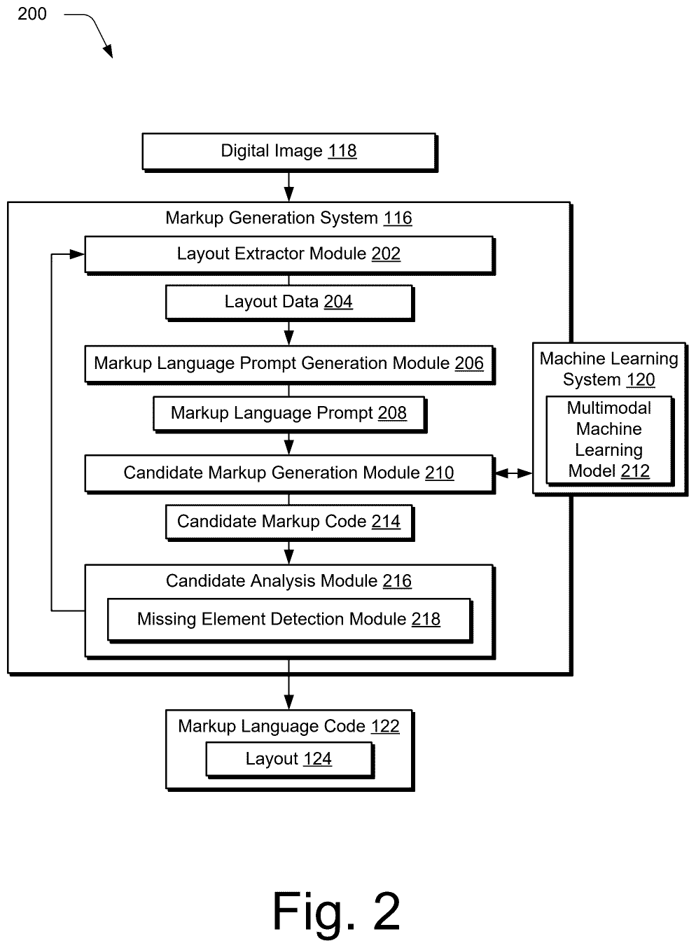

FIG. 2 depicts a system in an example implementation showing operation of a markup generation system of FIG. 1 in greater detail as generating markup language code from a digital image having a layout that corresponds to a digital image.

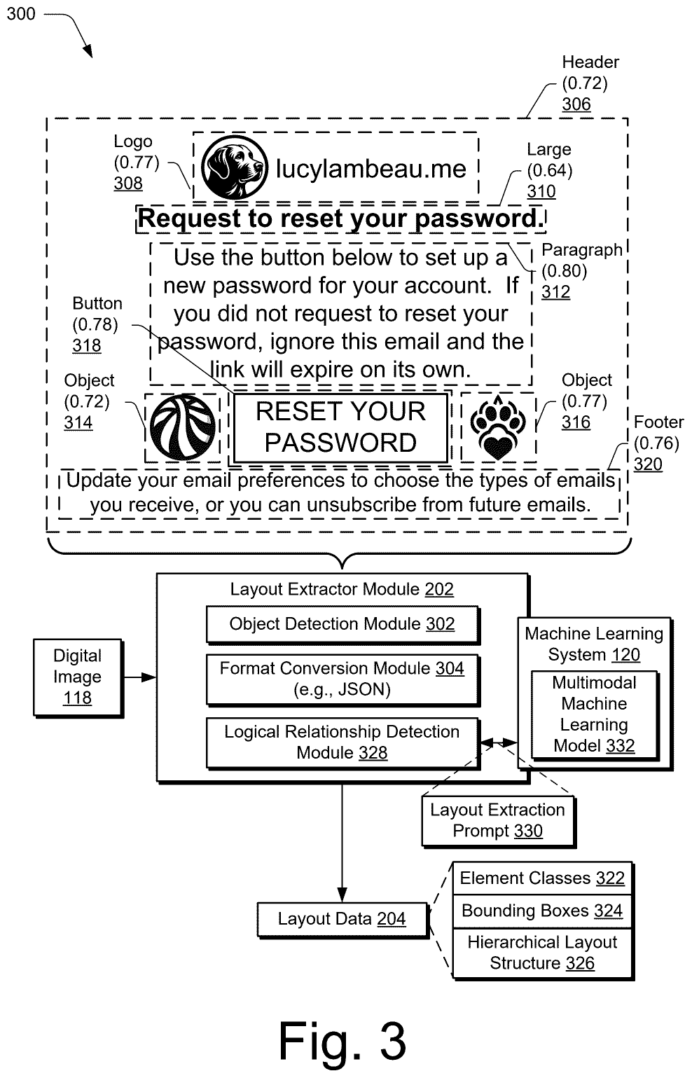

FIG. 3 depicts a system in an example implementation showing operation of a layout extractor module of FIG. 2 in greater detail.

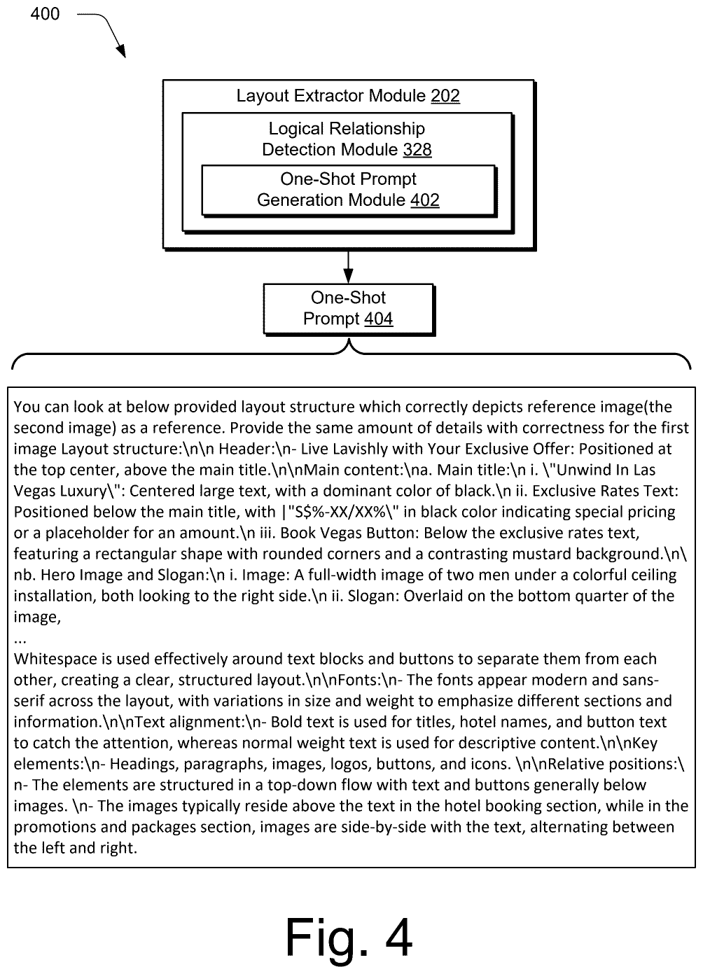

FIG. 4 depicts an example implementation of use of a one-shot prompt generation module of a logical relationship detection module of FIG. 3 as generating a one-shot prompt.

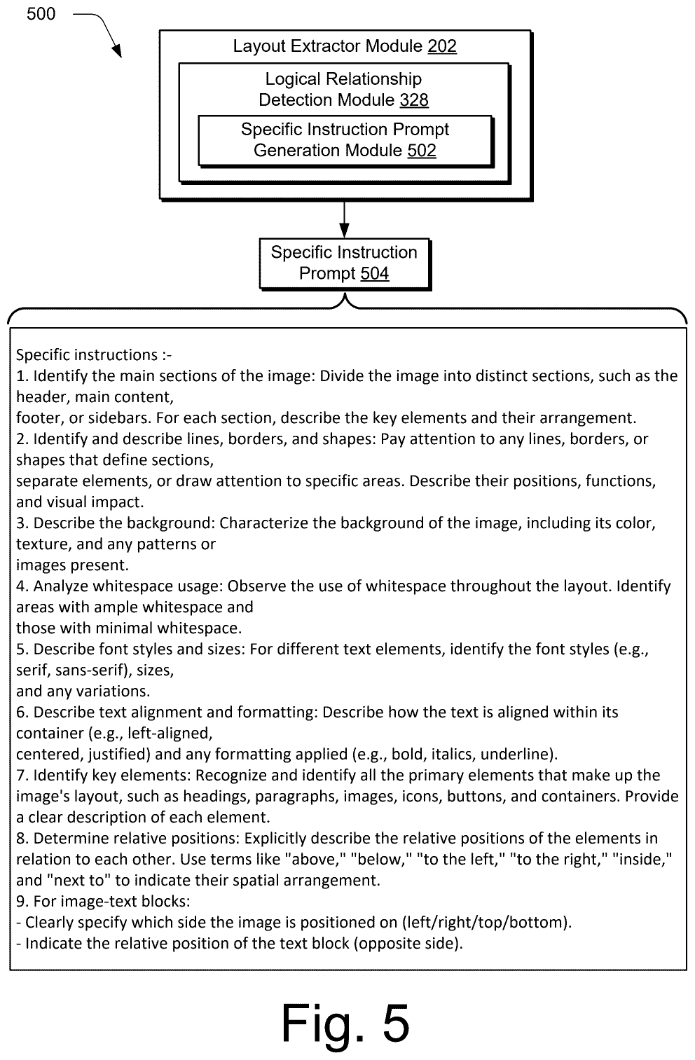

FIG. 5 depicts an example implementation of a specific instruction prompt generation module of a logical relationship detection module of FIG. 3 as generating a specific instruction prompt as a layout extraction prompt to a multimodal machine-learning model.

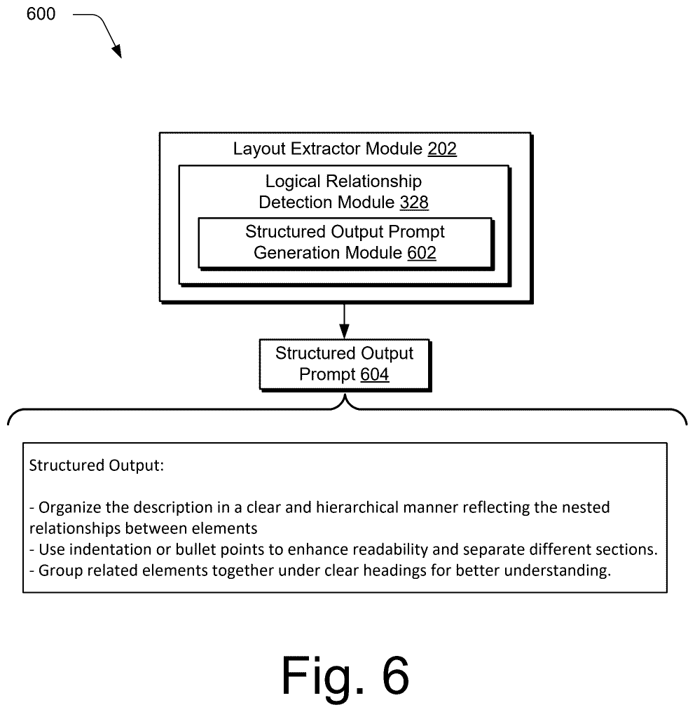

FIG. 6 depicts an example implementation of a structured output prompt generation module of a logical relationship detection module of FIG. 3 as generating a structured output prompt as a layout extraction prompt to the multimodal machine-learning model.

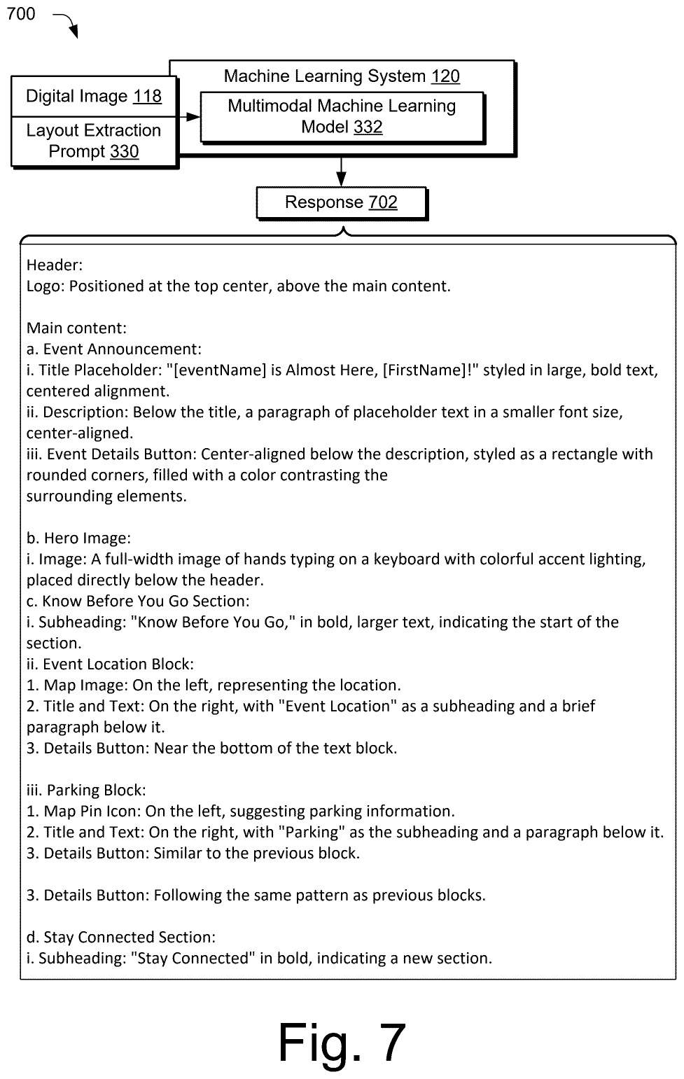

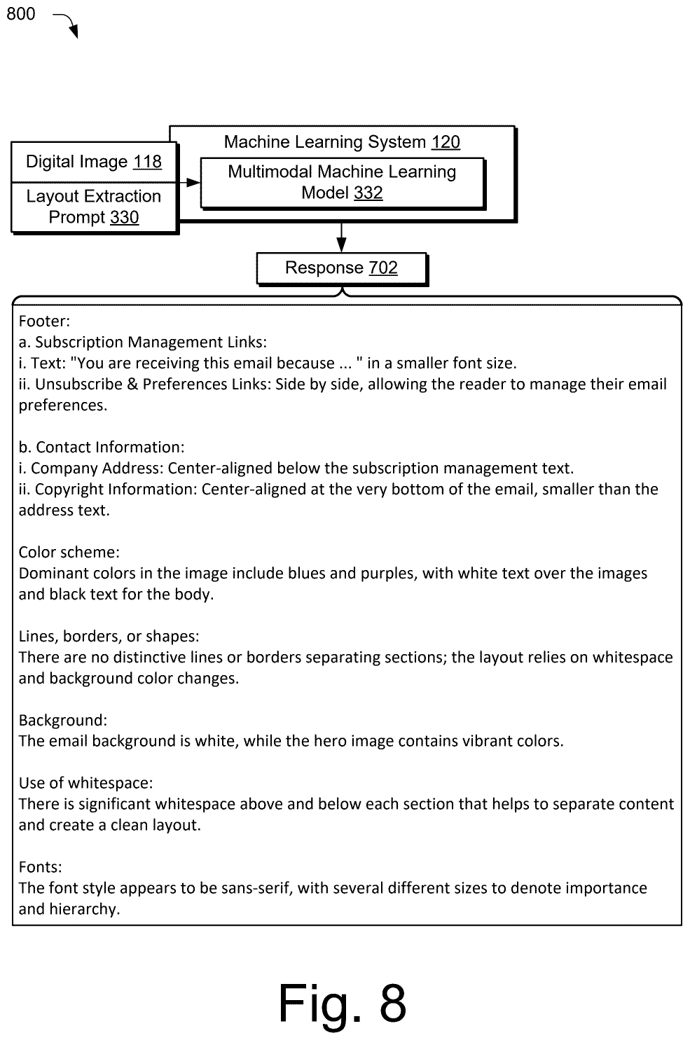

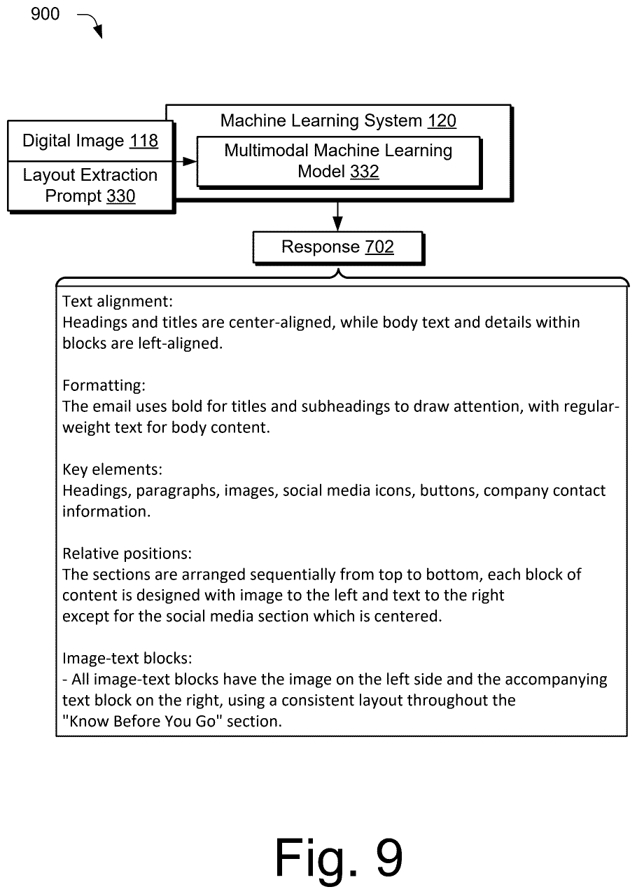

FIGS. 7, 8, and 9 depict examples of a response generated by a multimodal machine-learning model through processing of a digital image and a layout extraction prompt as generated in relation to FIGS. 3-6.

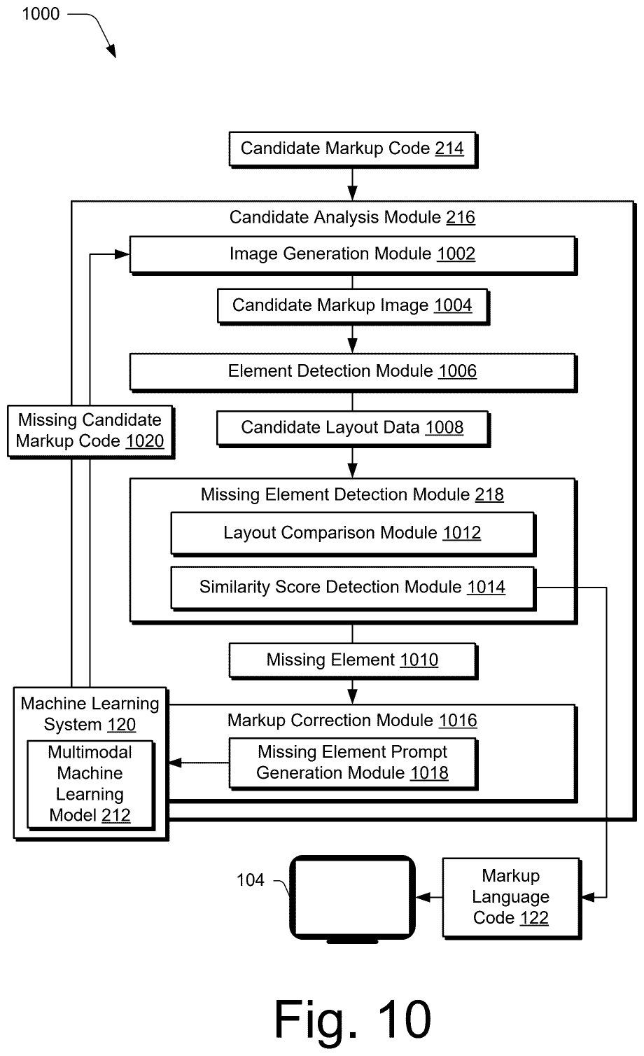

FIG. 10 depicts a system in an example implementation showing operation of a candidate analysis module of FIG. 2 in greater detail as performing missing element analysis over one or more iterations.

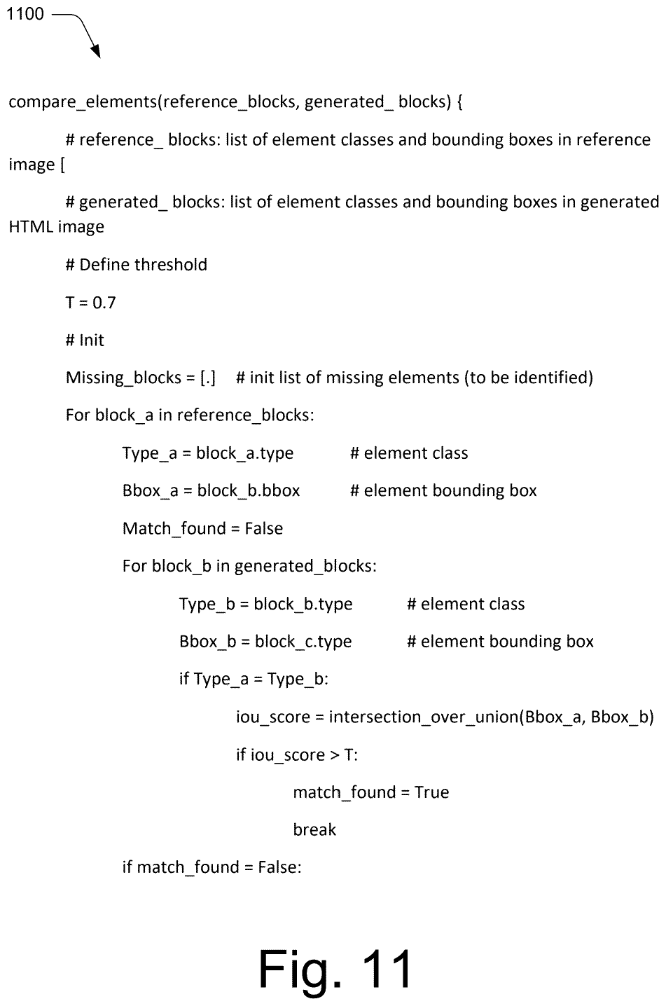

FIG. 11 depicts an example implementation of pseudocode for identifying one or more missing elements in a candidate markup code as implemented by the candidate analysis module of FIG. 10.

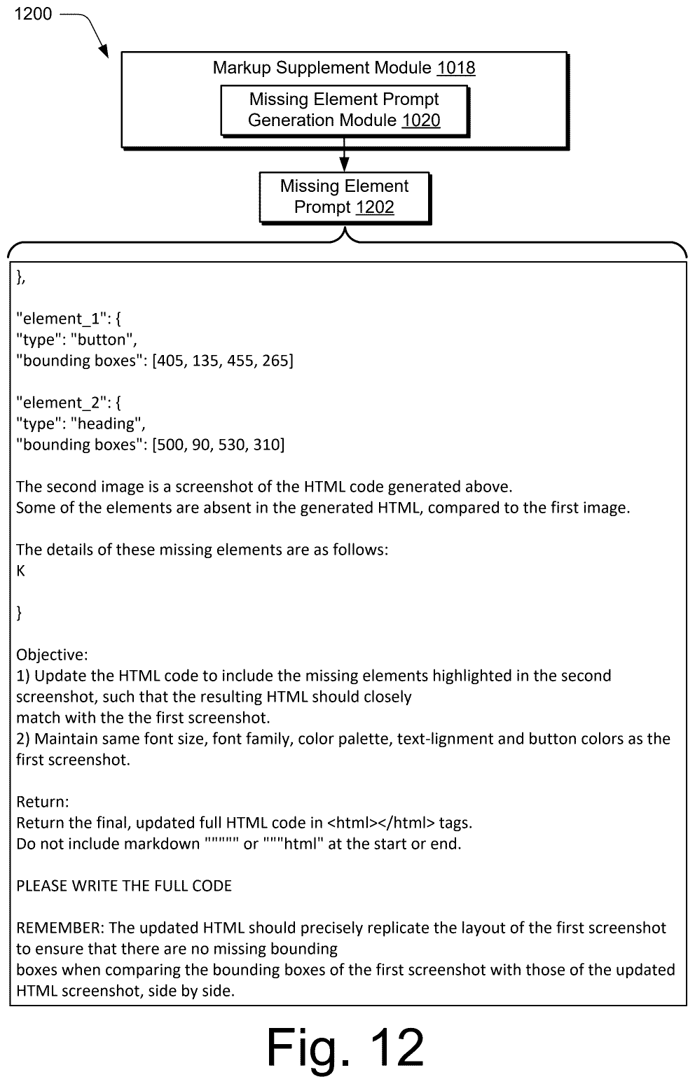

FIG. 12 depicts an example implementation of a missing element prompt generation module of a markup correction module of FIG. 10 as generating a missing element prompt to a multimodal machine-learning model.

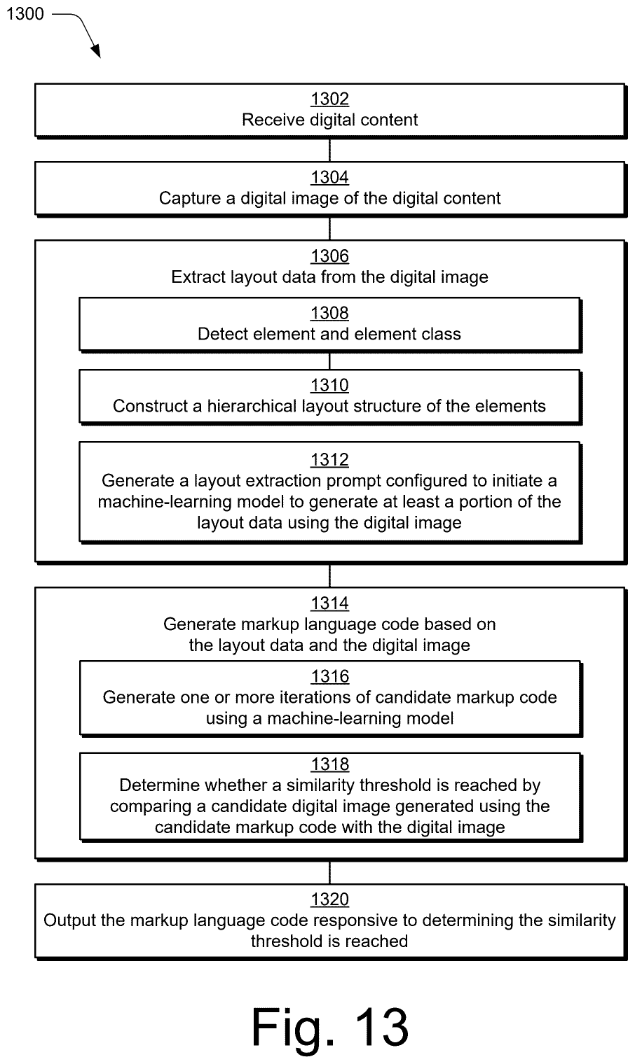

FIG. 13 is a flow diagram depicting an algorithm as a step-by-step procedure in an example implementation of operations performable for accomplishing a result of code generation from a digital image captured of digital content.

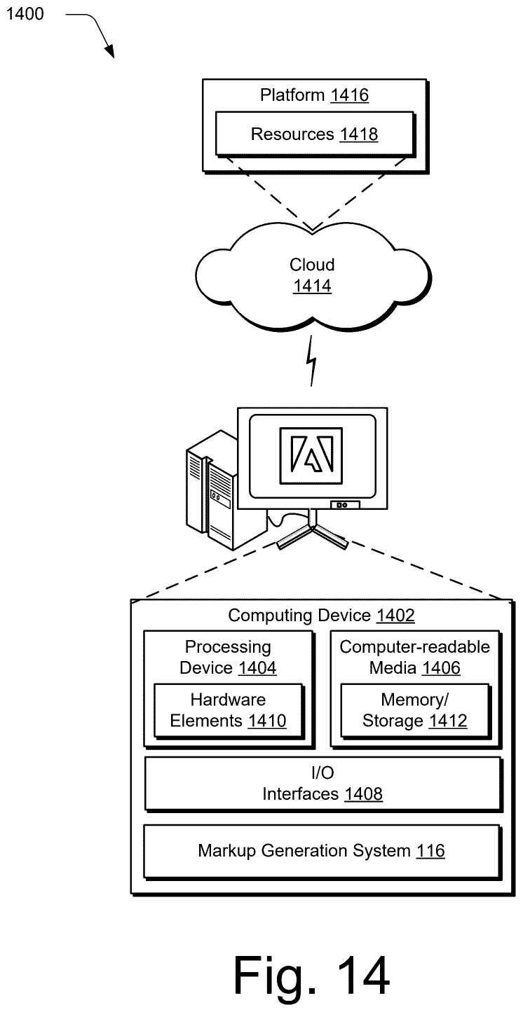

FIG. 14 illustrates an example system including various components of an example device that can be implemented as any type of computing device as described and/or utilize with reference to the previous figures to implement embodiments of the techniques described herein.

### DETAILED DESCRIPTION

### Overview

Markup languages have been developed to expand the ways, in which, digital content is expressed for consumption using a wide range of computing devices, e.g., desktop computers, mobile phones, tablet computers, and so forth. Markup language examples include use of a hypertext markup language (HTML), extensible markup language (XML), scalable vector graphics (SVG), mathematical markup language (MathML), and so forth. HTML, for instance, is often used by digital content such as webpages and email messages to specify arrangement of items (e.g., text, objects, logos, etc.) within the digital content to respond to rendering by different types of devices having diverse configurations, user interface sizes, and so forth.

Conventional techniques used to develop markup language code usable to implement these different types of digital content, however, often rely on specialized knowledge and skill developed over a period of time. As such, these techniques are often limited to use by experienced professionals in order to develop rich or sophisticated digital content. Further, even in instances in which these skills are developed, conventional techniques rely on manual recreation of the digital content which is time and computationally intensive, e.g., to edit the digital content for use in a similar scenario, and so forth.

Accordingly, code generation techniques from a digital image are described that are configurable to address these and other technical challenges in support of digital content creation, automatically and without user intervention. The code generation techniques, for instance, are configurable to employ machine learning through use of a machine-learning model to generate code (e.g., markup language code or other types of code that are executable by a processing device) automatically and without user intervention from a digital image, e.g., captured from digital content.

To do so, the code generation techniques are configurable to extract layout data from the digital image and use the layout data as a guide along with the digital image as a prompt to a machine-learning model to generate the executable code. Further, the code generation techniques are also configurable to employ an iterative process. As part of the iterative process, missing elements from candidate markup code are identified added to a resulting markup language code that is executable to implement the digital content, e.g., recreate an appearance of the digital image. In this way, the code generation techniques are usable to improve accuracy in code generation as following a layout of the digital content, which is not possible in conventional coding techniques.

In one or more examples, digital content is received by a markup generation system and a digital image is captured of the digital content, e.g., a digital image of a webpage, email, and so forth as a “screen capture.” Layout data is then extracted from the digital image. The markup generation system, for instance, may employ techniques to detect bounding boxes of elements included in the digital image and element classes of the elements, e.g., as an object, image, text, title, paragraph, footer, and so forth. The markup generation system is then configurable to generate a hierarchical layout structure of the elements, e.g., as a JavaScript Object Notation (JSON) object.

The markup generation system is also configurable to employ machine learning through use a machine-learning model to extract the layout data. The markup generation system, for instance, is configurable to generate one or more layout extraction prompts to cause the machine-learning model to extract at least a portion of the layout data from the digital image. Examples of layout extraction prompts include instructions configured to cause a machine-learning model to identify distinct sections of the digital image, determine relative position of the elements using spatial descriptors, identify text alignment and formatting attributes, recognize and describe lines, borders, dividers, or shapes, and/or explicitly specify a respective side, with respect to which, elements are located within the digital image. Accordingly, a result received from the machine-learning model in response to the layout extraction prompt is also configurable as layout data to define a layout of elements within the digital image. A variety of other examples are also contemplated.

The extracted layout data and the digital image are then used by the markup generation system to generate markup language code (or other types of code) through use a machine-learning model, which may be the same as or different from the machine-learning model used to extract the layout data. The markup generation system, for instance, leverages the machine-learning model to generate one or more iterations of candidate markup code in response to a markup language prompt that includes the digital image and instructions regarding how to generate the candidate markup code.

The markup generation system then determines whether a similarity threshold is reached by comparing a candidate digital image generated through execution of the candidate markup code with the digital image of the digital content. In instances in which a missing element is detected based on this comparison, the missing element is added to the candidate markup code and the process repeats until the similarity threshold is reached. Once reached, the generated markup code is then output, e.g., for execution to display the digital image, in support of editing of the code, and so forth.

As a result, the markup generation system is configurable to address conventional technical challenges, improve operational efficiency of computing device that implement these techniques, speed an ability to generate the digital content, and improve digital content generation accuracy. Further discussion of these and other examples is included in the following sections and shown in corresponding figures.

### TERM EXAMPLES

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both to the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Code Generation Environment

FIG. 1 is an illustration of a digital medium environment 100 in an example implementation that is operable to employ code generation techniques from a digital image as described herein. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources, e.g., mobile devices. Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 14.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a markup generation system 116, although the markup generation system 116 may also be implemented locally, e.g., at the computing device 104. The markup generation system 116 is configured to process a digital image 118 (e.g., captured of digital content) by a machine-learning system 120 to generate markup language code 122 defining a layout 124 based on elements included in the digital image 118.

As previously described, digital content is configurable in a variety of ways for use in a variety of usage scenarios. In the illustrated example as rendered in a user interface by the computing device 104, for instance, digital content as a webpage is shown having a plurality of elements that include text, headers, footers, logos, buttons, and so forth. The plurality of elements has a complex relationship to each other as part of presenting a visually appealing experience. However, conventional manual techniques utilized to generate the digital content involve specialized knowledge and experience and thus are typically unavailable for casual users and involve significant resource consumption even by experienced users.

Accordingly, the markup generation system 116 is configured to leverage vision and generative artificial intelligence (AI) techniques that are implemented using machine-learning models to generate markup language code 122 or other types of code for the digital content, automatically and without user intervention. The markup generation system 116, for instance, is configured to understand design elements such as structures, titles, font sizes, images, cascading style sheets, anchor links, and so on along with headers and footers to produce markup language code 122 having a layout 124 that corresponds to the digital content.

To do so, the markup generation system 116 receives a digital image 118 of the digital content in one or more examples, e.g., as a screenshot, capture from a buffer, and so forth. The markup generation system 116 then generates the markup language code 122 which is then usable in an editor to make changes to the digital content. User inputs, for instance, may be received via an editing application to add, update, edit, or change one or more elements within the markup language code 122. In this way, a consumer may view an item of digital content in a user interface and then convert the digital content into an editable form in an efficient and accurate manner. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

Example Code Generation Techniques from a Digital Image

The following discussion describes code generation techniques from a digital image that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 13 is a flow diagram depicting an algorithm 1300 as a step-by-step procedure in an example implementation of operations performable for accomplishing a result of code generation from a digital image captured of digital content. In portions of the following discussion, reference is made in parallel to FIG. 13.

FIG. 2 depicts a system 200 in an example implementation showing operation of the markup generation system 116 of FIG. 1 in greater detail as generating markup language code 122 from a digital image 118 having a layout 124 that corresponds to the digital image 118. To begin in this example, digital content is received (block 1302) and a digital image 118 is captured of the digital content (block 1304), which is passed to the markup generation system 116. The digital image 118, for instance, is capturable as a screen shot or other upload (e.g., via a user interface) of a variety of digital image formats, such as PNG, JPEG, WebP, and so forth. In this way, the digital image 118 is capturable from a variety of different types of digital content, e.g., presentations, webpages, emails, instant messages, etc.

A layout extractor module 202 is then employed by the markup generation system 116 to extract layout data 204 from the digital image 118 (block 1306). The layout data 204 is extracted by the layout extractor module 202 as a guide in understanding a layout of elements and semantics associated with those elements as part of understanding “what is included” in the digital image 118.

FIG. 3 depicts a system 300 in an example implementation showing operation of the layout extractor module 202 of FIG. 2 in greater detail. In a first example, element and element classes are detected from the digital image (block 1308) using an object detection module 302. A hierarchical layout structure of the elements is then constructed from the element and element classes (block 1310) using a format conversion module 304, e.g., to create a JavaScript Object Notation (JSON) object expressing a hierarchy of elements in the digital image 118 in relation to each other.

The object detection module 302, for instance, is configurable to perform bounding box detection as part of identifying elements and semantics associated with the elements from the digital image 118. This process includes recognizing elements such as objects, text and text types, buttons and so forth as well as extracting a relative location of those elements within the digital image 118. To achieve this, the object detection module 302 is configured to employ an object detection model (e.g., a machine-learning model) trained in identifying bounding boxes of elements within the digital image 118. The machine-learning model is also configurable to classify the elements into distinct semantic types as element classes 322, e.g., through use as a classifier.

In the illustrated example, the bounding boxes are shown using dashed lines along with element classes assigned to the respective elements and a probability that the element is associated with that element class. A header 306 element class having a probability of (0.72) is assigned, followed beneath by a logo 308 element class having a probability of (0.77). An element class of “large” 310 having a probability of (0.64) is assigned for text “Request to reset your password.” An element class of “paragraph” 312 is assigned for text at a probability of (0.80) with respect to objects 314, 316 for bounding boxes of objects of a ball and a pawprint having probabilities of (0.72) and (0.77), respectively. An element class of a button 318 for “reset your password” has a probability of (0.78) with finally an element class of a footer 320 having a probability of (0.76) for text “Update your email preferences to choose the types of emails you receive, or you can unsubscribe from future emails.”

Thus, in this first example the object detection module 302 breaks the digital image 118 into individual categorized elements as element classes 322 and bounding boxes 324 that are arranged according to a hierarchical layout structure 326 to serve as a strong prior for further processing by subsequent machine-learning models. Coordinates of individual bounding boxes, for instance, are provided as an input to a machine-learning model to generate markup data, styling, and so forth as further described below. Breaking the digital image 118 into elements provides several technical challenges, including support for an ability for human verification through output in a user interface and subsequent edits if warranted, e.g., to the element classes, bounding boxes, and so forth. Additionally, use of coordinates associated with the bounding boxes supports an ability of a subsequent machine-learning model to understand spatial context of the elements, e.g., with respect to the digital image 118 as well as in relation to each other.

In another example, a logical relationship detection module 328 is employed to generate a layout extraction prompt 330. The layout extraction prompt 330 is configured to initiate a machine-learning model (e.g., a multimodal machine-learning model 332 of the machine-learning system 120) to generate at least a portion of the layout data using the digital image (block 1312).

The logical relationship detection module 328 is utilized in this example to leverage capabilities of the multimodal machine-learning model 332 (e.g., a GPT-4 Vision model) to comprehensively analyze the digital image 118. The multimodal machine-learning model 332 is trained to interpret complex visual elements, ensuring a detailed understanding of the design elements. A variety of prompt configurations are supported by the logical relationship detection module 328 as part of generating the layout extraction prompt 330 for processing by the multimodal machine-learning model 332, examples of which are described in the following discussion.

FIG. 4 depicts an example implementation 400 of use of a one-shot prompt generation module 402 of the logical relationship detection module 328 as generating a one-shot prompt 404. To guide the multimodal machine-learning model 332, the layout extraction prompt 330 is provided with a reference image along with a “one-shot” prompt 404. The one-shot prompt 404 in one or more examples outlines an expected hierarchical layout structure 326 corresponding to the reference image. As a result, the layout extraction prompt 330, as a one-shot prompt 404, provides a clear example of the hierarchical layout structure 326, serving as a template for comprehension by the multimodal machine-learning model 332.

The one-shot prompt 404 is configured to cause the multimodal machine-learning model 332 to implement a variety of functionalities. Examples of these functionalities include an ability to identify distinct sections of the digital image, determine relative position of the elements using spatial descriptors, identify text alignment and formatting attributes, recognize and describe lines, borders, dividers, or shapes, and/or explicitly specify a respective side, with respect to which, elements are located within the digital image.

The one-shot prompt 404, for instance, is configured to instruct the multimodal machine-learning model 332 to identify and divide the digital image 118 into distinct sections, such as the header, main content, footer, or sidebars. For each section, the multimodal machine-learning model 332 is guided to describe the elements present and a corresponding arrangement, providing a comprehensive overview of a structural hierarchy of the digital image 118.

The one-shot prompt 404 also instructs the multimodal machine-learning model 332 to determine the relative positions of elements using spatial descriptors such as “above,” “below,” “to the left,” “to the right,” “inside,” and “next to.” This ensures an explicit understanding of the spatial properties of elements within the visual structure.

The one-shot prompt 404 further instructs the multimodal machine-learning model 332 to identify text alignment and formatting attributes within respective containers. The text alignment and formatting attributes describe aspects such as left alignment, center alignment, justification, and recognition of applied formatting like bold, italics, or underlining.

The one-shot prompt 404 also instructs the multimodal machine-learning model 332 to recognize and describe lines, borders, dividers, and shapes that define sections, separate elements, or draw attention to specific areas. This functionality provides insights into their positions, functions, and visual impact within the overall design.

Yet further, the one-shot prompt 404 instructs the multimodal machine-learning model 332 to explicitly specify a side on which images are positioned (left/right/top/bottom) within image-text blocks and indicate the relative position of associated text. This level of detail ensures a comprehensive understanding of spatial and formatting nuances in these specific design elements as part of the digital image 118.

FIG. 5 depicts an example implementation 500 of a specific instruction prompt generation module 502 as generating a specific instruction prompt 504 as a layout extraction prompt 330 to the multimodal machine-learning model 332. The specific instruction prompt 504 is configured to instruct the multimodal machine-learning model 332 to present the layout data 204 with clear headings that are distinctly delineated with bullet points in this example.

FIG. 6 depicts an example implementation 600 of a structured output prompt generation module 602 as generating a structured output prompt 604 as a layout extraction prompt 330 to the multimodal machine-learning model 332. The structured output prompt 604 is configured to instruct the multimodal machine-learning model 332 to comprehend a design as well as dissect and understand organization and composition of the digital image 118 at an increased level of granularity.

FIGS. 7, 8, and 9 depict examples 700, 800, 900 of a response 702 generated by the multimodal machine-learning model 332 through processing of the digital image 118 and the layout extraction prompt 330 to generate the layout data.

Returning again to FIG. 2, the layout data 204 is passed from the layout extractor module 202 as an input to a markup language prompt generation module 206. The markup language prompt generation module 206 is configured to generate a markup language prompt 208 configured to cause a machine-learning model to generate markup code. To do so, the markup language prompt generation module 206 is configured to generate the markup language prompt 208 to cause the machine-learning model to leverage an inferred layout structure, bounding boxes, and so forth defined by the layout data 204. This is accomplished through configuration of the markup language prompt 208 as a role-based prompt that encapsulates both an inferred layout structure and specific instructions for code generation to streamline the code generation process and improve computational resource efficiency.

The markup language prompt 208, for instance, is configurable to instruct a machine-learning model to use the layout data 204 as a layout representation and guiding framework during code generation. Emphasis is paced on accurately translation of each element into its corresponding code, ensuring a faithful representation of design intricacies of the digital image 118. The markup language prompt 208 is also configured to include instructions to provide a complete code as part of the output, which promotes seamless integration in subsequent editing functionality.

The markup language prompt generation module 206 is also configurable to include instructions to guide the inclusion of placeholder objects (e.g., images) in the output by the machine-learning model, which may also maintain dimensions as those present in the digital image 118. The markup language prompt 208 may also leverage element classes and corresponding bounding boxes from the layout data 204, which is configurable in a JSON format for parsing by the machine-learning model.

The markup language prompt 208 is also configurable to include a list of libraries that are leverageable by the machine-learning model to incorporate script, fonts, icons, and so forth. Use of the libraries enhances efficiency in generating the code. The markup language prompt 208 is also configurable to provide a resolution of the digital image 118. Thus, the markup language prompt 208 is configurable to implement a variety of functionalities to instruct the machine-learning model to use the layout data as a guiding framework during generation of the markup language code, provide the markup language code as a comprehensive output of the digital image, guide inclusion of at least one placeholder having dimensions based on those of a respective object in the digital image, maintain spatial properties of the elements of the digital image, and so on.

Markup language code 122 is then generated based on the layout data 204 and the digital image (block 1314), e.g., through use of the markup language prompt 208. To do so, a candidate markup generation module 210 is configured to initiate processing by a multimodal machine learning model 212 using the markup language prompt 208. One or more iterations of candidate markup code 214 are then generated using the machine-learning model (block 1316), e.g., the multimodal machine learning model 212.

A candidate analysis module 216 is then employed to determine whether a similarity threshold is reached by comparing a candidate digital image generated using the candidate markup code 214 with the digital image 118 (block 1318). The candidate analysis module 216, for instance, employs a missing element detection module 218 to determine whether the candidate digital image with the digital image 118. If a missing element is detected, the missing element is added to the candidate markup code 214 and the process continues over one or more additional iterations until the similarity threshold is met. Once met, the markup language code is then output (block 1320). The markup language code once output, for instance, is editable to add, remove, change, or reposition elements to edit the digital content.

FIG. 10 depicts a system 1000 in an example implementation showing operation of the candidate analysis module 216 of FIG. 2 in greater detail as performing missing element analysis over one or more iterations. The candidate analysis module 216 in this example receives candidate markup code 214 that is generated by extracting layout data from the digital image 118 as previously described. An image generation module 1002 is then employed to generate a candidate markup image 1004 based on the candidate markup code 214, e.g., by executing instructions specified by the candidate markup image 1004. The candidate markup image 1004, for instance, is rendered to obtain a screenshot image. The screenshot is captured at a specified resolution and resized to correspond to a size of the digital image 118.

An element detection module 1006 is then employed to detect candidate layout data 1008 including elements and element classes, bounding boxes, and so forth from the candidate markup image 1004. The element detection module 1006, for instance, may be implemented by the layout extractor module 202 to include functionality as previously described to detect element classes 322, bounding boxes 324, hierarchical layout structure 326, and so on from the candidate markup image 1004.

A missing element detection module 218 is then employed to detect a missing element 1010, e.g., as expressed in the candidate markup image 1004 rendered from the candidate markup code 214 and used to extract the candidate layout data 1008. The missing element detection module 218, for instance, is usable to compare layout data 204 generated from the digital image 118 with the candidate layout data 1008 generated from the candidate markup image 1004 using a layout comparison module 1012.

For each element in the digital image 118, for instance, the layout comparison module 1012 locates a corresponding element from the candidate markup image 1004, e.g., via the candidate layout data 1008, having a same element class. To do so, the layout comparison module 1012 computes an intersection over union (IOU) between respective bounding boxes. If a score of the intersection over union reaches a defined threshold (e.g., T equals 0.7), the elements are considered a match. If a match is not found for an element in the digital image 118, it is considered a missing element that was not accurately recreated in the candidate markup code 214. FIG. 11 depicts an example implementation 1100 of pseudocode for identifying one or more missing elements in a candidate markup code as implemented by the candidate analysis module of FIG. 10.

Once missing elements are curated by the missing element detection module 218, a markup correction module 1016 is leveraged to correct the candidate markup code 214 to support rendering of the missing element 1010. To do so in the illustrated example, a missing element prompt generation module 1018 is configured to generate a missing element prompt to cause the multimodal machine learning model 212 to generate missing candidate markup code 1020. FIG. 12 depicts an example implementation 1200 of a missing element prompt generation module of a markup correction module of FIG. 10 as generating a missing element prompt 1202 for use by a multimodal machine-learning model.

Another iteration is then performed through the 1002, element detection module 1006, missing element detection module 218 until a similarity threshold is reached as detected by a similarity score detection module 1014. The similarity threshold, for instance, may specify that the iterations are to continue until a missing element is not detected, fewer than a threshold number of elements, element classes, and so forth. Once the similarity threshold is reached, the candidate markup code 214 is output as the markup language code 122, e.g., for viewing and subsequent edits in a user interface by the computing device 104.

Accordingly, the markup generation system 116 is configurable to implement code generation techniques from a digital image to address conventional technical challenges in support of digital content creation, automatically and without user intervention. The code generation techniques, for instance, are configurable to employ machine learning through use of a machine-learning model to generate code (e.g., markup language code or other types of code that are executable by a processing device) automatically and without user intervention from a digital image, e.g., captured from digital content. As a result, the markup generation system is configurable to address conventional technical challenges, improve operational efficiency of computing device that implement these techniques, speed an ability to generate the digital content, and improve digital content generation accuracy.

### Example System and Device

FIG. 14 illustrates an example system generally at 1400 that includes an example computing device 1402 that is representative of one or more computing systems and/or devices that implement the various techniques described herein. This is illustrated through inclusion of the markup generation system 116. The computing device 1402 is configurable, for example, as a server of a service provider, a device associated with a client (e.g., a client device), an on-chip system, and/or any other suitable computing device or computing system.

The example computing device 1402 as illustrated includes a processing device 1404, one or more computer-readable media 1406, and one or more I/O interface 1408 that are communicatively coupled, one to another. Although not shown, the computing device 1402 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1404 is representative of functionality to perform one or more operations using hardware. Accordingly, the processing device 1404 is illustrated as including hardware element 1410 that is configurable as processors, functional blocks, and so forth. This includes implementation in hardware as an application specific integrated circuit or other logic device formed using one or more semiconductors. The hardware elements 1410 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1406 is illustrated as including memory/storage 1412 that stores instructions that are executable to cause the processing device 1404 to perform operations. The computer-readable storage medium is configured for storing instructions that, responsive to execution by the processing device, causes the processing device to perform operations. The memory/storage 1412 represents memory/storage capacity associated with one or more computer-readable media. The memory/storage 1412 includes volatile media (such as random access memory (RAM)) and/or nonvolatile media (such as read only memory (ROM), Flash memory, optical disks, magnetic disks, and so forth). The memory/storage 1412 includes fixed media (e.g., RAM, ROM, a fixed hard drive, and so on) as well as removable media (e.g., Flash memory, a removable hard drive, an optical disc, and so forth). The computer-readable media 1406 is configurable in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1402 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1402. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1402, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1410 and computer-readable media 1406 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1410. The computing device 1402 is configured to implement particular instructions and/or functions corresponding to the software and/or hardware modules. Accordingly, implementation of a module that is executable by the computing device 1402 as software is achieved at least partially in hardware, e.g., through use of computer-readable storage media and/or hardware elements 1410 of the processing device 1404. The instructions and/or functions are executable/operable by one or more articles of manufacture (for example, one or more computing devices 1402 and/or processing devices 1404) to implement techniques, modules, and examples described herein.

The techniques described herein are supported by various configurations of the computing device 1402 and are not limited to the specific examples of the techniques described herein. This functionality is also implementable all or in part through use of a distributed system, such as over a “cloud” 1414 via a platform 1416 as described below.

The cloud 1414 includes and/or is representative of a platform 1416 for resources 1418. The platform 1416 abstracts underlying functionality of hardware (e.g., servers) and software resources of the cloud 1414. The resources 1418 include applications and/or data that can be utilized while computer processing is executed on servers that are remote from the computing device 1402. Resources 1418 can also include services provided over the Internet and/or through a subscriber network, such as a cellular or Wi-Fi network.

The platform 1416 abstracts resources and functions to connect the computing device 1402 with other computing devices. The platform 1416 also serves to abstract scaling of resources to provide a corresponding level of scale to encountered demand for the resources 1418 that are implemented via the platform 1416. Accordingly, in an interconnected device embodiment, implementation of functionality described herein is distributable throughout the system 1400. For example, the functionality is implementable in part on the computing device 1402 as well as via the platform 1416 that abstracts the functionality of the cloud 1414.

In implementations, the platform 1416 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
extracting, by a processing device, layout data from a digital image, the layout data describing a layout of elements included in the digital image;
generating, by a processing device, markup language code by generating one or more iterations of candidate markup code using a machine-learning model based on the digital image and the layout data and determining whether a similarity threshold is reached by comparing a candidate digital image generated using the candidate markup code with the digital image; and
outputting, by the processing device, the markup language code responsive to determining the similarity threshold is reached.

2. The method as described in claim 1, wherein the layout data defines bounding boxes of the elements, elements classes of the elements, and a hierarchical layout structure of the elements.

3. The method as described in claim 1, wherein the extracting includes generating a layout extraction prompt configured to initiate a machine-learning model to generate at least a portion of the layout data using the digital image.

4. The method as described in claim 3, wherein the layout extraction prompt includes instructions to cause the machine-learning model to:
identify distinct sections of the digital image;
determine relative position of the elements using spatial descriptors;
identify text alignment and formatting attributes;
recognize and describe lines, borders, dividers, or shapes; or
explicitly specify a respective side, with respect to which, elements are located within the digital image.

5. The method as described in claim 1, wherein the generating includes generating a markup language prompt configured to initiate the machine-learning model to generate the candidate markup code.

6. The method as described in claim 5, wherein the markup language prompt is configured to instruct the machine-learning model to use the layout data as a guiding framework during generation of the markup language code.

7. The method as described in claim 5, wherein the markup language prompt is configured to instruct the machine-learning model to provide the markup language code as a comprehensive output of the digital image.

8. The method as described in claim 5, wherein the markup language prompt is configured to instruct the machine-learning model to guide inclusion of at least one placeholder having dimensions based on those of a respective object in the digital image.

9. The method as described in claim 5, wherein the markup language prompt is configured to instruct the machine-learning model to maintain spatial properties of the elements of the digital image.

10. The method as described in claim 1, wherein the generating the one or more iterations of candidate markup code using the machine-learning model includes:
identifying a missing element based on the comparing of the candidate digital image generated using the candidate markup code with the digital image;
initiating generation of missing candidate markup code as part of the one or more iterations of generating the candidate markup code based on the missing element; and
the comparing includes comparing a respective said candidate markup image generated based on the missing candidate markup code with the digital image.

11. A computing device comprising:
a processing device; and
a computer-readable storage medium storing instructions that, responsive to execution by the processing device, causes the processing device to perform operations including:
extracting layout data from a digital image, the layout data describing a layout of elements included in the digital image;
generating candidate markup code using one or more machine-learning models based on the digital image and the layout data;
identifying a missing element by comparing the digital image with a candidate digital image generated through execution of the candidate markup code;
initiating generation of missing candidate markup code based on the missing element using the one or more machine-learning models;
determining a similarity threshold is reached by comparing a missing candidate digital image generated using the missing candidate markup code with the digital image; and
outputting markup language code based on the missing candidate markup code.

12. The computing device as described in claim 11, wherein the extracting is performed using the one or more machine-learning models.

13. The computing device as described in claim 11, wherein the digital image is a webpage or an email.

14. One or more computer-readable storage media storing instructions that, responsive to execution by a processing device, causes the processing device to perform operations comprising:
generating a layout extraction prompt to instruct one or more machine-learning models to extract layout data based on elements included in a digital image, the layout data describing bounding boxes of the elements, elements classes of the elements, and a hierarchical layout structure of the elements;
receiving the layout data from the one or more machine-learning models;
generating a markup language prompt based on the layout data and the digital image, the markup language prompt configured to instruct the one or more machine-learning models to generate markup language code; and
receiving the markup language code from the one or more machine-learning models.

15. The one or more computer-readable storage media as described in claim 14, wherein the layout extraction prompt includes instructions to cause the machine-learning model to:
identify distinct sections of the digital image;
determine relative position of the elements using spatial descriptors;
identify text alignment and formatting attributes;
recognize and describe lines, borders, dividers, or shapes; or
explicitly specify a respective side, with respect to which, elements are located within the digital image.

16. The one or more computer-readable storage media as described in claim 14, wherein the markup language prompt is configured to instruct the one or more machine-learning models to use the layout data as a guiding framework during generation of the markup language code.

17. The one or more computer-readable storage media as described in claim 14, wherein the markup language prompt is configured to instruct the one or more machine-learning models to provide the markup language code as a comprehensive output of the digital image.

18. The one or more computer-readable storage media as described in claim 14, wherein the markup language prompt is configured to instruct the one or more machine-learning models to guide inclusion of at least one placeholder having dimensions based on those of a respective object in the digital image.

19. The one or more computer-readable storage media as described in claim 14, wherein the markup language prompt is configured to instruct the one or more machine-learning models to maintain spatial properties of the elements of the digital image.

20. The one or more computer-readable storage media as described in claim 14, further comprising generating the digital image for display in a user interface by executing the markup language code by one or more processing devices.
